(19) United States
(12) Patent Application Publication
(10) Pub. No.: US 2009/0188432 A1
(43) Pub. Date: Jul. 30, 2009

(54) DISPOSABLE WILD BIRD FEEDER

(75) Inventor: Joseph E. McMullen, Greenville, SC (US)

Correspondence Address: NATRIUM, LLC, 9 FISHER ROAD, GREENVILLE, SC, 29615, US

(73) Assignee: NATRIUM, LLC

(21) Appl. No.: 12/011,134

(22) Filed: Jan. 24, 2008

(51) Int. Cl. A01K 39/01

(52) U.S. Cl. 119/57.9; 119/57.8

(57) ABSTRACT

The present invention is a wild bird feeder with the features that make it safe and easy to use but protected from being reused. A reservoir containing bird seed is connected with a feeding base using an adaptor. The feeding base is threaded to the adaptor which in turn is threaded to the reservoir. A stop attached to the feeding base and a locking adaptor seat keeps the assembled wild bird feeder from being taken apart and refilled. The wild bird feeder converts from a first storage position to a second feeding position by partially unthreading the feeding base from the adaptor so bird seed is supplied to the bottom portion of the feeding base. A plurality of perches are supported by the feeding base. The perches are moved from a stored position to a properly deployed position when second feeding position is realized. A label is placed on the reservoir to provide a logo, directions for use and bird seed data.

### BACKGROUND OF THE INVENTION

This invention is directed to wild bird feeder and more particularly to an economical design that allows the feeder to be discarded when used. In particular, the feeder has only essential parts that can be easily produced to provide the necessary components to be an effective and safe feeder for wild birds.

The most commonly used disposable wild bird feeders are configured to have a top reservoir portion containing bird seed in combination with a perch portion and feeding ports for the wild bird to access the feed. For most feeders a problem exists as a result of the feed becoming contaminated or unusable before it is totally consumed. For example, the feed may become moist resulting in an accumulation of solids and mold inside the reservoir. Cleaning of the reusable feeder must be frequent to maintain a desirable level of performance. Adequate cleaning is difficult for several reasons; requiring the use of a variety of tools to remove the contaminated feed. Proper cleaning is critical for maintaining the health of the birds before reusing any feeder. In general, this is not done very well. In addition, the supply of wild bird feed should be protected with utmost care so the feeder is filled with safe clean uncontaminated bird seed. These tasks are best done by those that manufacture the feeder, not the user.

According to the invention, a disposable feeder is intended for use only once. It is initially filled with wild bird seed for storage and shipping and is easily converted to form the bird feeder itself with only minor changes from the food storage configuration. The feeder has a container for the food, at least one access port for the beak of the birds associated with at least one perch for the birds, a closure to prevent loss of the food through the port during storage and a hangar portion to support the feeder in its place of use safe from predators.

A further problem of many conventional wile bird feeders can results from ants and other crawling insects. The ants and insects travel down the hangar portion to reach the reservoir and feeding ports. In tests, conventional wild bird feeders were found to require cleaning every few days in order to remove accumulated ants or insects. A solution to this problem is disclosed in U.S. Pat. No. 4,901,673. This patent discloses an upward opening receptacle at the top of the reservoir filled with an insect inhibiting fluid to provide an effective barrier for ants and insects. A solution similar but structurally different to this art is provided in this invention.

Disposable bird feeders are well known in the art. The best prior art and most commonly used disposable wild bird feeders typical of the industry are disclosed in U.S. Pat. Nos. 7,093,562; 4,989,548; 4,958,595; 4,947,797; 4,606,298; 4,242,984; 4,233,941; 4,104,987; 3,441,002; 2,775,226; 2,340,976; D278,169; and D252,643. However, several problems have been encountered with disposable wild bird feeders known in the art. Some structures made of bendable sheet material of plastic or cardboard are not durable and require extensive assembly or partial assembly of a plurality of parts. Another problem with some feeders is that, when the container is converted to a feeder, sidewalls are pushed inward and held by locking tabs or friction making them unreliable in use. Other feeders have only a single perch and access port making them less efficient for feeding a number of wild birds. The '562 patent discloses various means for locking a feeder assembly to a reservoir to help make it a one time only feeder. However these coupling means are complex and expensive to make. Other feeders have extensive roof and/or perch structures also making them expensive to make. The present invention overcomes the above problems by providing a storage reservoir which is inexpensive to manufacture but simple and positive in its operation to provide a wild bird feeder from the reservoir.

Inasmuch as the art is relatively crowded with respect to wild bird feeders, it can be appreciated that there is a continuing need for and interest in improvements to such feeders. In this respect, the present invention addresses this need and interest.

Accordingly, it is the objective an object of the present invention is to provide a wild bird feeder with a simple and rugged design that is ready to put into service, safe to use and designed to discourage being refilled.

An essential object of the present invention is to provide a disposable wild bird feeder that is capable of being converted from a storage container into a feeder with a minimum of effort or skill at no expense.

Another object of the present invention is to provide a feeder construction that makes multiple perches and access ports available to the wild birds.

Yet another object of the present invention is to provide a feeder as in the foregoing objectives of simple and rugged design and low manufacturing cost so disposal is economically viable.

Yet a further object of the invention is the provision of protecting the access ports from rain water collecting and contaminating the feed contained in the feeder.

One additional object of the present invention is to provide a means to protect the feed from contamination by ants and other insects.

Another additional object is to provide a label on the feeder that gives operational directions and warnings concerning possible contamination with reuse of the feeder.

### SUMMARY OF THE INVENTION

The present invention is a wild bird feeder with the features that make it safe and easy to use but resistant to being reused. A reservoir containing bird seed is connected with a feeding base using an adaptor. The feeding base is threaded to the adaptor which in turn is threaded to the reservoir. A stop attached to the feeding base and a locking adaptor seat keeps the assembled wild bird feeder from being easily taken apart and refilled. The wild bird feeder converts from a first storage position to a second feeding position by partially unthreading the feeding base from the adaptor so bird seed is supplied to the bottom portion of the feeding base. A plurality of perches are supported by the feeding base. The perches are moved from a stored position to a properly deployed position when second feeding position is realized. A label is placed on the reservoir to provide a logo, directions for use, bird seed data and contamination warnings from reuse.

In a first embodiment of the invention a disposable wild bird feeder is provided comprising a reservoir initially filled with bird seed having a closed recessed top and an open cylindrical bottom formed to include interior threads. An adaptor has a collar with interior and exterior collar threads. The exterior collar threads interface with the interior threads of the reservoir for connecting the adaptor to the reservoir. A feeding base has a bottom portion with a base collar and a center post supporting a base ring. The base ring has ring threads that interface with the interior collar threads of the adaptor so that a first storage position is realized by the base collar making contact with the adaptor and a second feeding position is realized when the base collar is rotationally displaced from the adaptor to allow the bird seed to reach said bottom portion of the feeding base and provide an access port for feeding the wild birds. A plurality of perches supported by the feeding base are provided to be extended from the feeding base when the second feeding position is realized.

In one aspect of the first embodiment the adaptor has a saw tooth adaptor seat and the reservoir has at least one protrusion to interface with the said saw tooth adaptor seat to lock the adaptor to the reservoir forming a partial assembly of the feeder so that the adaptor and the reservoir cannot be easily separated after said assembly. In addition, a stop is attached to the top edge of the base ring of the feeding base during assembly of the feeder so that the feeding base can be initially threaded to the adaptor but not removed from the adaptor when the adaptor is subsequently threaded to the reservoir to form a complete assembly.

In a further aspect of the first embodiment the base ring of the feeding base has a center throat area and at least one seed aperture to allow the bird seed to reach the bottom portion of the feeding base when the feeding base is in the second feeding position.

In a second embodiment a method to provide a wild bird feeder to be abandoned after being used is given. A first step is providing a reservoir, with one cylindrical end open and internally threaded and the other end closed and recessed, plus an adaptor and a feeding base. A second step includes placing the reservoir on a surface with the closed end downward and filling the reservoir through the open end with bird seed. In a third step the method includes threading the feeding base into the adaptor until a base collar of the feeding base is in contact with a rain guard of the adaptor to provide an initial assembly. A fourth step includes installing a stop on the feeding base so that the feeding base can be only partially unthreaded from the adaptor (as in the eighth step). A fifth step includes providing a saw tooth adaptor seat and outer collar threads on the adaptor and at least one locking protrusion on the open threaded end of the reservoir. In a sixth step the method comprises threading the adaptor and feeding base initial assembly onto the open end of the reservoir until the locking protrusion of the reservoir is locked with the saw tooth adaptor seat providing a completely assembled feeder. A seventh step includes turning the assembled feeder over and hanging the assembled feeder in an appropriate use location from a hangar tab in the recessed portion of the closed end of the reservoir. In a eighth step the method further includes partially unthreading the feeding base from the adaptor to allow the bird seed to flow into a bottom portion of the feeding base to be accessed through an access port. A ninth step includes providing a plurality of perches slidably supported by the feeder base and deploying the perches from the feeding base so that the wild birds can land and access the bird seed through the access port. In a tenth step the method comprises discarding the wild bird feeder when said bird seed has been depleted.

### DESCRIPTION OF THE DRAWINGS

The construction designed to carry out the invention will hereinafter be described, together with other features thereof.

The invention will be more readily understood from a reading of the following specification and by reference to the accompanying drawings forming a part thereof, wherein an example of the invention is shown and wherein:

FIG. 1 is a perspective view of the disposable wild bird feeder of this invention showing a cylindrical reservoir, an adaptor and a feeding base for supplying access ports with bird seed, wherein associated perches have been deployed from the feeding base for the wild birds to feed.

FIG. 2 is a top view of the wild bird feeder of the invention showing the cylindrical reservoir connected above the adaptor with a recessed center portion of the reservoir having a hangar tab for supporting the feeder during use.

FIG. 2A is an exterior side view taken along line 2A-2A in FIG. 2 and in FIG. 4 showing the locking interface between the reservoir and the adaptor.

FIG. 3 is a bottom view of the wild bird feeder of the invention showing a plurality of perches in a stored position against the feeding base prior to placing the feeder in use.

FIG. 4 is a cross-sectional view, taken along line 4-4 in FIG. 2 or FIG. 3, showing the reservoir threaded to an adaptor which supports a feeding base, wherein the feeder is in a first position for storing bird seed.

FIG. 5 is a cross-sectional view, also taken along line 4-4 in FIG. 2 but modified to show the feeding base in a second position extended from the adaptor to allow the seed to flow into the feeding base, wherein the perches are radially extended to accommodate the birds while feeding.

FIG. 6 is a top plan view of the feeding base of the invention illustrating seed apertures for discharging bird seed onto the bottom of the feeding base, wherein the perches are extended from the feeding base.

FIG. 7 is a cross-sectional view of the feeding base, taken along line 7-7 in FIG. 6, showing one of the seed apertures and the perches extended from the feeding base.

FIG. 8 is a top plan view of the adaptor of the invention illustrating a collar with a sloping top surface, a locking adaptor seat and a rain guard.

FIG. 9 is an elevation view of the adaptor, taken along line 9-9 in FIG. 8, showing outer collar threads and a locking adaptor seat that interfaces with the reservoir and a rain guard of the adaptor.

FIG. 10 is a cross-sectional view, taken along line 10-10 in FIG. 8, showing an adaptor collar with outer collar threads that interface with the reservoir and inner collar threads that interface with the feeding base.

### DETAILED OF A PREFERRED EMBODIMENTS

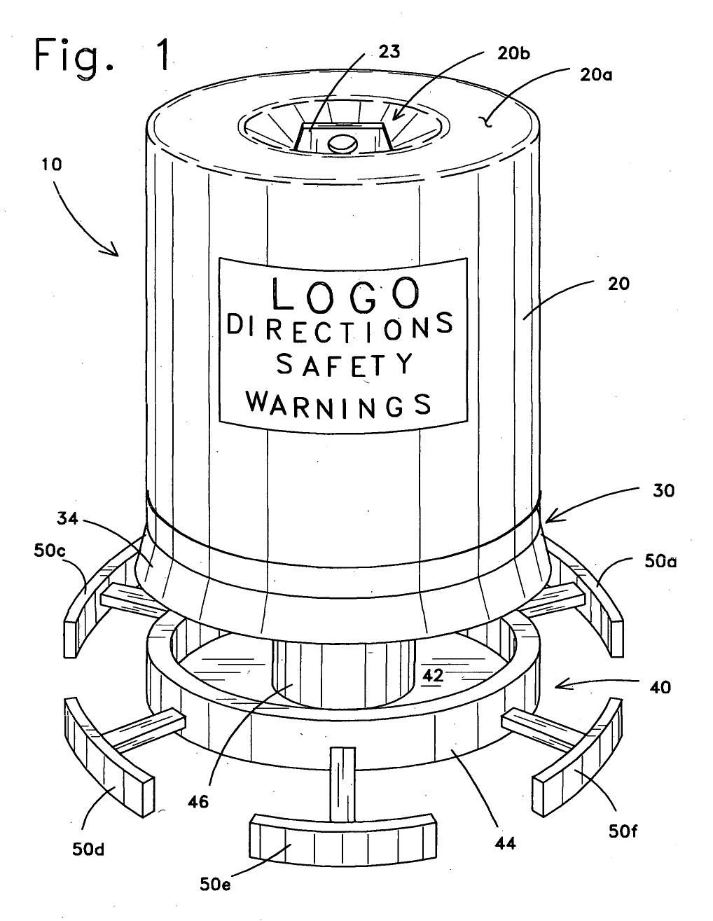

Referring now in more detail to the drawings, the invention will now be described in more detail. A perspective view of a wild bird feeder 10 in a feeding position according to this invention is illustrated in FIG. 1. A reservoir 20 containing bird seed is connected to an adaptor 30 which supports a feeding base 40. The feeding base has been displaced from the adaptor by a center post 46 to provide access to a bottom portion 42 that is supplied with bird seed from the reservoir. Details on how the bird seed reaches the bottom portion from the reservoir is described later. A base collar 44 helps retain the bird seed and supports a plurality of perches 50a-50f for the wild birds to land while they are feeding. A rain guard 34 of the adaptor helps keep the bird seed in the bottom portion from becoming wet. The top surface 20a of the reservoir has a recess 20 that contains a hangar tab 23 for hanging the feeder during use.

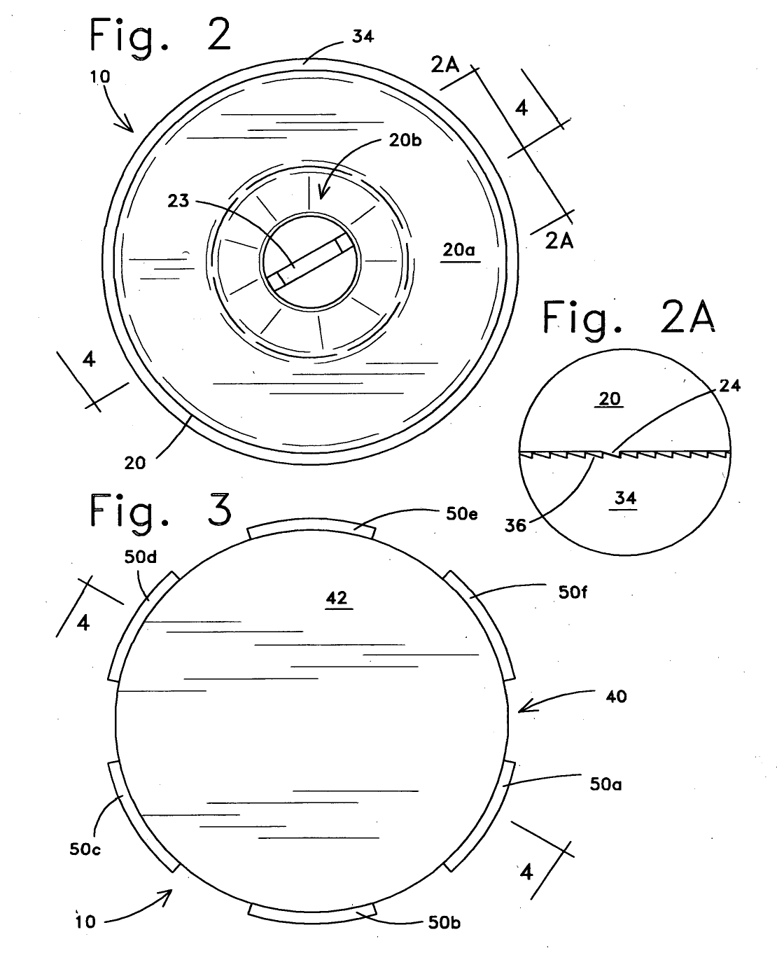

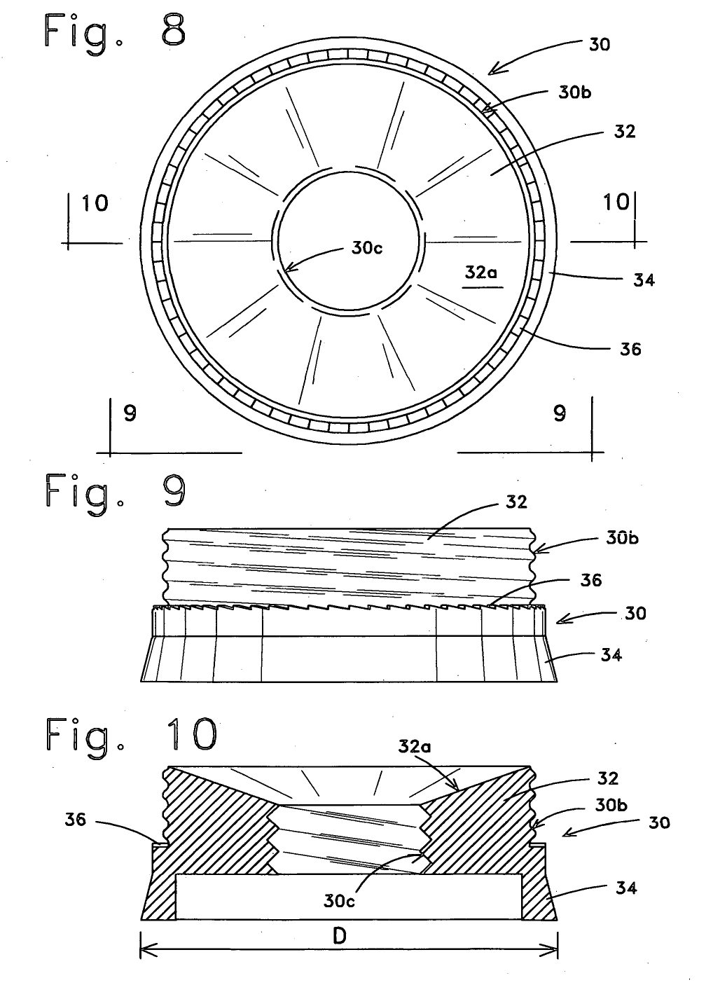

A top plan view of wild bird feeder 10 is shown in FIG. 2 and a bottom view is shown in FIG. 3 for a cylindrical reservoir in a stored position. The preferred shape of the reservoir is cylindrical. Other shapes of the top portion of the reservoir are within the scope of the invention; including rectangular, square and the like. The other shapes can also include rounded comers. However, the reservoir must have a cylindrical lower portion with threads for connecting with the threaded adaptor 30 (see FIG. 9). Perches 50a-50f of the wild bird feeder are also in the storage position adjacent the bottom portion 42. Top surface 20a is preferably a flat surface for better storage of the feeder prior to being used. Recessed top 20b has hangar tab 23 centrally located so that the feeder can hang vertically. The recessed top can be used as a moat for adding an oil around the hangar tab to inhibit ants and insects from crawling down the reservoir and contaminating the bird seed.

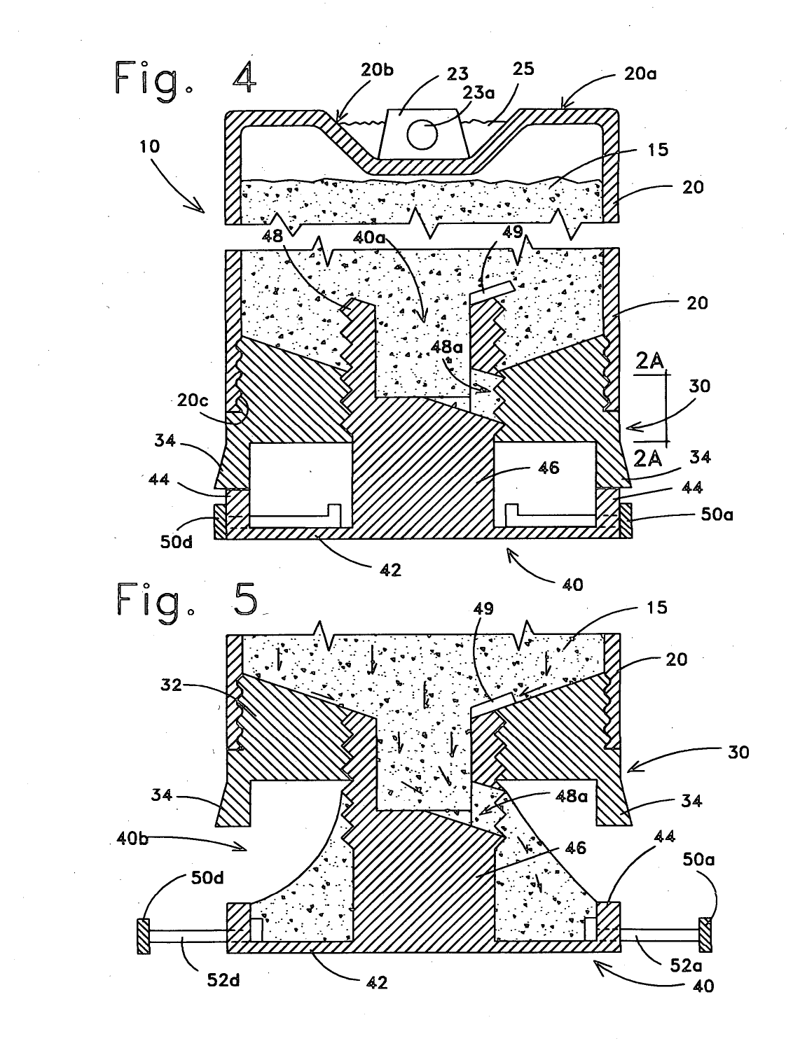

Details of the wild bird feeder are illustrated in the cross-sectional view of FIG. 4. This view is taken along line 4-4 in FIG. 2 and FIG. 3 and shows bird seed 15 within reservoir 20. This view is with the feeder in a first storage position where the bird seed is stored in the reservoir prior to use. The feeder has two bottom sections that are assembled together with the reservoir. Adaptor 30 includes an adaptor collar 32 which is threaded onto interior reservoir threads 20c at the cylindrical bottom end of the reservoir. A locking mechanism at the bottom end of the reservoir is provided, as illustrated in the side elevation view of FIG. 2A taken along line 2A-2A. At least one reservoir protrusion 24 interfaces with a saw tooth adaptor seat 36 to lock the adaptor to the reservoir to prevent future removal of the adaptor from the reservoir. The adaptor collar also has internal threads to receive feeding base 40 threaded into the adaptor.

Feeding base 40 has a base ring 48 formed integral with center post 46. The base ring is threaded into adaptor 30 until base collar 44 makes contact with rain guard 34 of the adaptor. The center bore of the base ring provides a throat area 40a for bird seed 15 to flow into the feeding base. In this first storage position, illustrated in FIG. 4, the bird seed is blocked from flowing into bottom portion 42 of the feeding base. All perches 50a-50f are in a stored position adjacent base collar 44.

The top end, of the reservoir is also shown in the cross-sectional view of FIG. 4. Top surface 20a is flat to assist in the stacking of feeders when in storage, during shipping and on sale. Recessed top 20b provides space for hangar tab 23 without interfering with the flat top surface as well as oil 25 to block the progress of ants and insects that are after the bird seed. A hangar aperture 23a provides for using a hangar (not shown) to support the wild bird feeder.

Feeding base 40 is rotated downward from adaptor 30 to convert the feeder from the first storage position into the second feeding position, as illustrated in the cross-sectional view of FIG. 5. A stop 49 attached to the top edge of base ring 48 limits the extent of downward travel of the feeding base below the adaptor. This stop is installed after the feeding base is initially threaded on the adaptor during assembly of the feeder. Moving the feeding base downward allows bird seed 15 to flow into bottom portion 42 through at least one seed aperture 48a of base ring 48. These apertures are blocked by the adaptor during the first storage position of the feeder. The space generated between rain guard 34 and base collar 44 provides a bird access port 40b extending circumferentially around the feeder. The perches 50a-50f are extended to provide a place for the wild birds to land and access the bird seed through the access port.

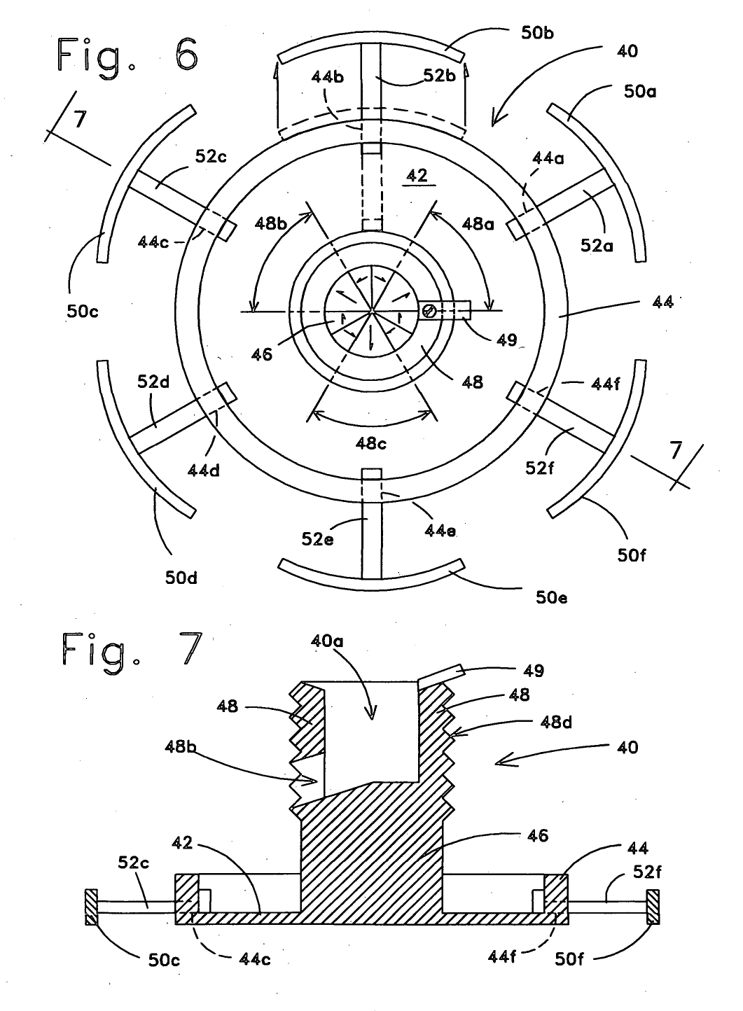

Additional details of feeding base 40 are provided by illustrating the feeding base alone. A plan view of the feeding base is illustrated in FIG. 6 and a cross-sectional view is illustrated in FIG. 7. The plan view shows the feeding base in the second feeding position with perches 50a-50f deployed from base collar 44. Each perch has a respective arm 52a-52f that extends through a respective slot 44a-44f in the base collar. Each perch is moved from the first stored position to the properly deployed position, as illustrated by the arrows of perch 50b. Each arm is turned up at the end to provide a stop against removal of a perch. Movement to be partially deployed is possible for smaller birds to be able to reach the bird seed in bottom portion 42. The slots can also provide an outlet for moisture that may get into in the bottom portion. Base ring 48 is supported by center post 46 and includes at least one seed aperture. Preferably, there are multiple seed apertures 48a-48c to provide a good distribution of bird seed in the bottom portion. The center post is sloped on the top, as shown by the arrows, to assist the bird seed in reaching a respective seed aperture in the base ring. Stop 49 is attached to the top of the base ring after the feeding base is threaded on the adaptor. The stop prevents removal of the feeding base from the assembled ready-to-use feeder to help prevent reuse of the feeder.

The cross-sectional view of FIG. 7 illustrates center bore throat area 40a and one of the seed apertures 48b in base ring 48 supported by center post 46. This cross-section is taken along line 7-7 in FIG. 6. The seed apertures are sloped to assist the bird seed in reaching bottom portion 42 of feeding base 40. Ring threads 48d interface with inner collar threads 30c of the adaptor (see FIG. 10). Stop 49 is placed on a slope to match the slope of the top of the adaptor. Once again, perches 50c and 50f are properly extended from base collar 44 in the deployed second feeding position.

Additional details of the adaptor are provided by illustrating the adaptor alone. A plan view of adaptor 30 is shown in FIG. 8, an elevation view is shown in FIG. 9 and a cross-sectional view is shown in FIG. 10. Adaptor collar 32 is formed with an adaptor top surface 32a which slopes downward to the center of the adaptor. Outer collar threads 30b interface with the reservoir threads to connect the adaptor to the reservoir. Inner collar threads 30c interface with the base ring of the feeding base. Rain guard 34 has a outer diameter “D” larger than the outer diameter of the base collar of the feeding base. This larger diameter helps to divert rain water from the bottom portion of the feeding base. Locking adaptor seat 36 has a saw tooth configuration to interface with at least one reservoir protrusion (see FIG. 2A).

The materials used for reservoir 20 are preferably plastic or glass. A transparent feature may be incorporated to allow the user to gage the amount of bird seed 15 remaining in the reservoir before the wild bird feeder is to be replaced. The transparent reservoir is also important for attracting birds to the feeder. The reservoir is specifically designed to prevent spoilage by making the reservoir small to provide only a few days supply of the bird seed. The preferred capacity is about one quart or a liter.

The preferred bird seed 15 is a mixture of seeds including but not limited to sunflower, millet, milo, oat, barley and/or corn seeds. These seeds are commonly found as “wild bird seed” in the feed and seed stores or supermarkets. The seed is added by the manufacturer prior to the sale of the wild bird feeder to control the type and quality of bird seed. A label is added to each bird feeder describing the bird seed contained therein. The wild bird feeder of this invention can not be refilled with seed when the bird seed is consumed without damaging the feeder. This helps protect the wild birds from contaminated feed as a result of refilling the feeder.

An ant and insect inhibiting fluid added in the recessed top 20b (see FIG. 4) is preferably a non-toxic mineral oil 25. The oil provides an effective barrier which prevents insects, and especially ants, from traveling down the hangar to the feeding base and into the bird seed. The insect inhibiting fluid may also comprise some form of insecticide or agent or water treated with a wetting agent such as soap.

The material used for adaptor 30 and feeding base 40, as well as the perches, are preferably of a plastic material. Other materials, such as a metal or wood, can also be used within the scope of this invention. Once again, the adaptor has a saw tooth adaptor seat which meshes with at least one protrusion of the reservoir so that the adaptor can not be easily removed from the reservoir after assembly of the wild bird feeder. In addition, a stop is provided on the feeding base during assembly of the feeding base with the adaptor so that the feeding base can not be removed from the adaptor after assembly of the wild bird feeder. That is, once the wild bird feeder is assembled with the bird seed added, it can not be taken apart to add more bird seed and used again without considerable effort.

While a preferred embodiment of the invention has been described using specific terms an a particular prior art reference, such description is for illustrative purposes only, and it is to be understood that changes and variations may be made without departing from the spirit or scope of the following claims. The foregoing is considered to be illustrative only of the principles of the invention. Since numerous modifications and changes will readily occur to those skilled in the art, it is not desirable to limit the invention to the exact construction and operation shown and described. The general size and shape of the feeder can vary to accommodate birds of different size and capacity to consume the feed. Accordingly, all suitable modifications and equivalents may be resorted to, falling within the scope of this invention. All equivalent relationships to those illustrated in the drawings and described in the specifications are intended to be encompassed by the present invention.

What is claimed is:

1. A disposable wild bird feeder comprising:
a reservoir initially filled with bird seed having a closed recessed top and an open cylindrical bottom formed to include interior threads;
an adaptor having a collar with interior and exterior collar threads, wherein said exterior collar threads interface with said interior threads of said reservoir for connecting said adaptor to said reservoir;
a feeding base having a bottom portion with a base collar and a center post supporting a base ring, wherein said base ring has ring threads that interface with said interior collar threads of said adaptor so that a first storage position is realized by the base collar making contact with said adaptor and a second feeding position is realized when said base collar is rotationally displaced from the adaptor to allow the bird seed to reach said bottom portion of said feeding base and provide access ports for feeding the wild birds; and
a plurality of perches supported by said feeding base to be extended from said feeding base when said second feeding position is realized.

2. The wild bird feeder of claim 1 wherein said adaptor has a saw tooth adaptor seat and said reservoir has at least one protrusion to interface with said saw tooth adaptor seat to lock said adaptor to said reservoir forming a partial assembly of the feeder so that said adaptor and said reservoir cannot be easily separated after said assembly.

3. The wild bird feeder of claim 2 including a stop attached to the top edge of said base ring of said feeding base during assembly of the feeder so that said feeding base can be initially threaded to the adaptor but not removed from said adaptor when the adaptor is subsequently threaded to said reservoir to form a complete assembly.

4. The wild bird feeder of claim 1 wherein said adaptor includes a rain guard having an outer diameter greater than an outer diameter of said base collar to help protect the feeding base from receiving rain water.

5. The wild bird feeder of claim 1 wherein said base ring of said feeding base has a center throat area and at least one seed aperture to allow said seed to reach said bottom portion of said feeding base when said feeding base is in said second feeding position.

6. The wild bird feeder of claim 5 wherein there are three seed apertures equally spaced around said base ring of said feeding base.

7. The wild bird feeder of claim 5 wherein said at least one seed aperture is blocked by said adaptor from discharging said bird seed into said bottom portion of said feeding base when said first storage position is realized.

8. The wild bird feeder of claim 1 wherein said recessed top portion of said reservoir includes a hangar tab with an aperture to receive a hangar to hang the wild bird feeder in an optimum location.

9. The wild bird feeder of claim 8 wherein said recessed top portion provides a moat to receive an insect inhibiting fluid to form a barrier against insects reaching said bird seed.

10. The wild bird feeder of claim 1 including a plurality of perches supported by arms and adjustably extending from slots in said base collar of said feeding base, wherein said slots also drain rain water from said base.

11. The wild bird feeder of claim 10 wherein said plurality of perches are placed in contact with said base collar of said feeding base when the feeder is in said first storage position and are extended from said base collar when the feeder is in said second feeding position.

12. The wild bird feeder of claim 11 wherein there are six perches equally spaced circumferentially said feeding base.

13. The wild bird feeder of claim 1 including a label placed on said reservoir to communicate at least operational instructions and information on the danger of contamination of said bird seed by refilling and reusing said feeder when empty.

14. The wild bird feeder of claim 1 wherein said reservoir has an upper portion with a polygonal shape with round comers and a cylindrical lower portion to interface with said adaptor.

15. A method to provide a wild bird feeder that is disposed of after being used comprising the steps of:
a) providing a reservoir with one open an internally threaded cylindrical end and the other end closed and recessed, an adaptor and a feeding base;
b) placing said reservoir on a surface with said closed end downward and filling said reservoir through said open end with bird seed;
c) threading said feeding base into said adaptor until a base collar of said feeding base is in contact with a rain guard of said adaptor to provide an initial assembly;
d) installing a stop on said feeding base so that said feeding base can be only partially unthreaded from said adaptor (as in step h);
e) providing a saw tooth adaptor seat and outer collar threads on said adaptor and at least one locking protrusion on said open threaded end of said reservoir;
f) threading said adaptor and feeding base initial assembly onto said open end of said reservoir until said at least one locking protrusion of said reservoir is locked with said saw tooth adaptor seat providing a completely assembled feeder;
g) turning said assembled feeder over and hanging said assembled feeder in an appropriate use location from a hangar tab in said recessed portion of said closed end of said reservoir;
h) partially unthreading said feeding base from said adaptor to allow said bird seed to flow into a bottom portion of said feeding base to be accessed through an access port;
i) providing a plurality of perches slidably supported by said feeding base and properly deploying said perches from said feeding base so that the wild birds can land and access said bird seed through said access port; and
j) discarding the wild bird feeder when said bird seed has been depleted.

16. The method of claim 15 wherein the method of allowing said bird seed to flow into said bottom portion of said feeding base includes providing a throat area and a plurality of seed apertures in a base ring of said feeding base.

17. The method of claim 15 further including the step of placing a label on said reservoir including information on the use of the feeder and a warning concerning the danger to the wild birds by reusing said feeder.

18. The method of claim 15 wherein the step of providing said plurality of perches includes the steps of providing an arm with a turned up end for each one of said perches and extending said arm through a slot in said base collar of said feeding base to prevent removal of said respective perch from said feeding base.
